(19) United States
(12) Patent Application Publication
(10) Pub. No.: US 2011/0147653 A1
(43) Pub. Date: Jun. 23, 2011

(54) PREPARATION METHOD FOR GAS ABSORBENT MATERIAL

(75) Inventor: Svetlana M. Zemskova, Edelstein, IL (US)

(73) Assignee: Caterpillar Inc., Peoria, IL (US)

(21) Appl. No.: 12/975,486

(22) Filed: Dec. 22, 2010

Related U.S. Application Data
(60) Provisional application No. 61/288,906, filed on Dec. 22, 2009.

(51) Int. Cl. B01J 20/10

(52) U.S. Cl. 252/184

(57) ABSTRACT

A wet milling process for the creation of a mineral carbonation precursor material containing alkaline earth metal silicate and an alkaline earth metal oxide and the combining of the mineral carbonation precursor material with exhaust gases containing CO₂ and/or SO₂ to create an exhaust gas deprived of CO₂ and/or SO₂ and a carbonated and/or sulfated product of the mineral carbonation precursor material.

### TECHNICAL FIELD

This disclosure relates to the broad technical area of carbon capture and storage (CCS) and, more specifically, is an improvement to mineral carbonation.

### BACKGROUND

Many technologies have been developed to capture and sequester carbon dioxide (CO₂) from exhaust gases of combustion processes; some solutions involve the handling of compressed carbon dioxide and the injection of concentrated CO₂ within the earth (geologic sequestration) or at deep ocean floors. Unfortunately, these solutions do not guarantee that the CO₂ will not be released at some point in the future. Mineral carbonation, on the other hand, stores CO₂ in mineral form by converting mineral compounds to a low energy state compound that contains the CO₂ chemically bound and stable as a carbonate. Mineral carbonation is a thermodynamically favorable means for CO₂-capture but has unfavorable kinetics that require improved solutions for increasing the conversion rate (both in terms of reaction speed and total precursor successfully converted).

The kinetics of mineral carbonation can be improved by increasing the surface area of the precursor particles. This can be achieved chemically through mineral dissolution, as disclosed in U.S. Pat. No. 7,604,787, where an acid is used to dissolve carbon capturing minerals in the preparation of an active slurry. This method does successfully increase the activity of the precursor mineral(s), but requires the handling of strong acids and the cost of such ingredients. Furthermore, this method requires a second step of titrating the dissolved precursor slurry with a base in order to raise the pH and increase the rate of precipitation of metal carbonate from the slurry.

A solution that improves the kinetics of mineral carbonation without the handling of acid or concentrated base solutions is needed.

### SUMMARY OF THE INVENTION

This disclosure describes a process that increases the mineral carbonation conversion rate of mineral carbonation precursor minerals compared to untreated dry-milled powders of the same precursor minerals.

According to one aspect of the invention, a naturally occurring alkaline earth metal silicate is modified by a process of wet milling to create a mineral carbonation precursor with better chemical reactivity than the alkaline earth metal silicate exhibited without modification. The alkaline earth metal silicate may be selected from any number of naturally occurring magnesium and calcium bearing minerals. Examples of such minerals include (but are not limited to) the minerals olivine, serpentine, pyroxene, peridotite, monticellite, forsterite, wollastonite, diopside, and tremolite.

According to another aspect of the invention, an alkaline earth metal silicate is modified by a process of wet milling wherein the slurry also contains an alkaline earth metal oxide, for example MgO or CaO. The wet milling process occurs in a high pH slurry due to the addition of the MgO or CaO (quicklime). The wet milling process increases the surface area of the precursor minerals compared to untreated dry-milled powders of the same precursor minerals. The surface area increase due to wet milling is achieved by blending the alkaline earth metal silicate and alkaline earth metal oxide, furthermore, the observed surface area increase is greater than could be achieved by wet milling the precursor alkaline earth metal silicate alone (without the inclusion of the alkaline earth metal oxide in the slurry). The wet milling process may impart ionic exchange between the alkaline earth metal silicate and the alkaline earth metal oxide. For example, forsterite (Mg₂SiO₄) wet milled with quicklime (CaO) results in a precipitate with a chemical composition revealing both Mg and Ca bound with the silicate.

### BRIEF DESCRIPTION OF THE DRAWINGS

FIG. 1 shows representative data for the uptake of CO₂ in untreated olivine using a cycle of alternating CO₂ enriched gas and pure N₂.

FIG. 2 shows representative data for the uptake of CO₂ for a mineral carbonation precursor prepared according to one aspect of this invention using a cycle of alternating CO₂ enriched gas and pure N₂.

FIG. 3 shows representative data for the uptake of CO₂ for a mineral carbonation precursor prepared according to one aspect of this invention at various temperatures using a cycle of alternating CO₂ enriched gas and pure N₂.

FIG. 4 shows representative data for the uptake of SO₂ for a mineral carbonation precursor prepared according to one aspect of this invention at various temperatures using a cycle of alternating CO₂ enriched gas and pure N₂.

### DETAILED DESCRIPTION

Alkaline earth metal silicates prepared according to the process of this disclosure exhibit better reactivity than as-received dry powders. This improvement can be attributed chemical and/or morphological changes imparted to the materials during the disclosed wet milling process.

A wet milling process can have various levels of effectivity in reducing particle size, increasing surface area, and changing mineral composition of the precursors depending on the process parameters. Some of process parameters that may be varied include: milling time, temperature, selection of grinding media, slurry concentration, choice of silicate, choice of oxide, milling speed, and chemical additives (e.g. pH modifiers, surfactants, anti-foaming agents, chelating agents, etc.). Some trends expected for these parameters include; for example, that lengthening the milling time would generally reduce particle size and increase surface area. Some of the parameters that are expected to reduce particle size and increase surface area are costly in terms of time and/or money, it is desirable to minimize incurring unnecessary expense in regard to those parameters.

Table 1 discloses mineral carbonation precursor materials prepared according to the wet-milling process of this disclosure. These samples were wet-milled with two different types of grinding media: samples A, B, C, and D were prepared with ˜½″ alumina cylindrical grinding media, while samples E, F, G, and H were prepared with ˜¼″ zirconia cylindrical grinding media. The total weight of mineral carbonation precursor material prepared under each condition remained the same throughout the study: about 20 grams. The surface area of the resultant material shows high sensitivity to the silicate:oxide ratio with more CaO resulting in higher surface area. The data shows that the approximately 7 hour milling time with the ˜¼″ zirconia cylinders was generally preferred to a longer milling time with ˜½″ alumina cylinders, and that a concentrated slurry (less water) was preferred to a dilute slurry (more water).

TABLE 1

| Sam- | Oli- | | | Milling | Milling | Milling | Surface |
|---|---|---|---|---|---|---|---|
| ple | vine | CaO | H₂O | Time | Temp | Media | Area |
| A | 19 g | 1 g | 15 g | 24 h | 23° C. | ½″ alumina | 6.5 m²/g |
| | | | | | | cylinders | |
| B | 19 g | 1 g | 45 g | 24 h | 23° C. | ½″ alumina | 7.6 m²/g |
| | | | | | | cylinders | |
| C | 17 g | 3 g | 30 g | 24 h | 23° C. | ½″ alumina | 13.1 m²/g |
| | | | | | | cylinders | |
| D | 15 g | 5 g | 15 g | 24 h | 23° C. | ½″ alumina | 17.3 m²/g |
| | | | | | | cylinders | |
| E | 19 g | 1 g | 45 g | 7 h | 60° C. | ¼″ zirconia | 8.3 m²/g |
| | | | | | | cylinders | |
| F | 17 g | 3 g | 30 g | 7 h | 60° C. | ¼″ zirconia | 9.7 m²/g |
| | | | | | | cylinders | |
| G | 15 g | 5 g | 15 g | 7 h | 60° C. | ¼″ zirconia | 25.8 m²/g |
| | | | | | | cylinders | |
| H | 15 g | 5 g | 45 g | 7 h | 60° C. | ¼″ zirconia | 17.5 m²/g |
| | | | | | | cylinders | |

| | |
|---|---|
| as-received olivine | 3.2 m²/g |
| as-received CaO | 7.0 m²/g |

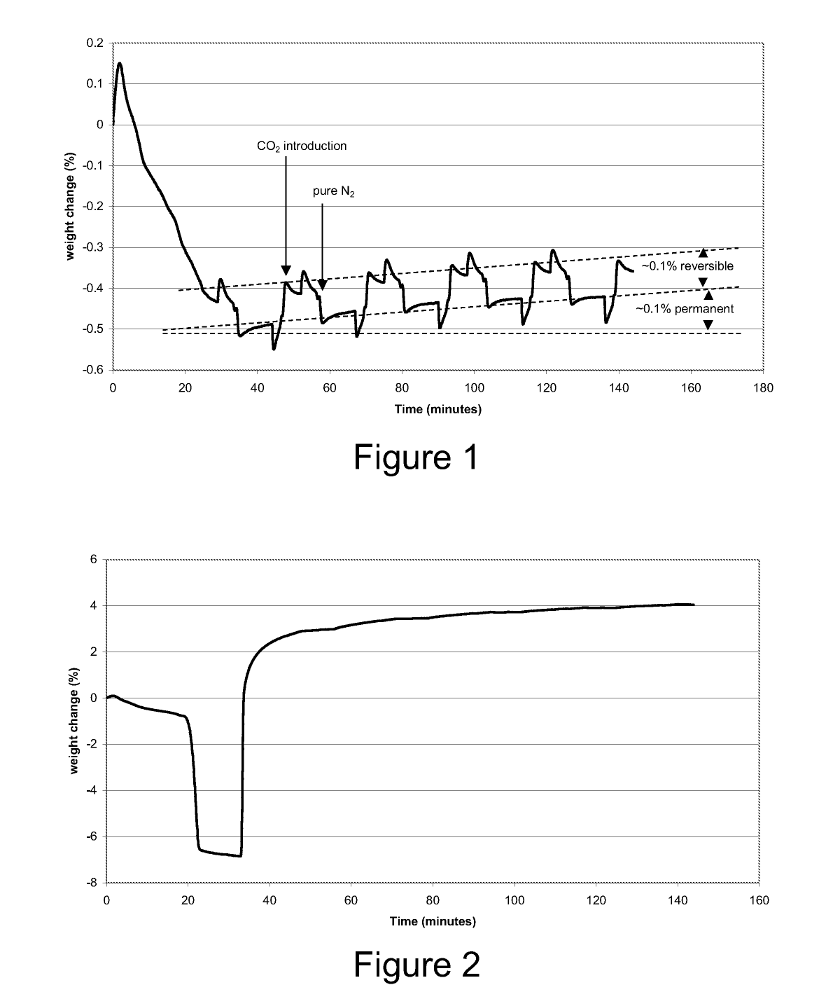

In order to adequately discern the improvement in reactivity of the materials prepared according to the disclosed process, FIG. 1 is included to show baseline data for an as-received sample of olivine. The weight change of the sample is shown on the vertical axis while time is the variable on the horizontal axis. FIG. 1 shows the weight response of olivine under cyclical introduction of CO₂. The first approximately 30 minutes of the test shows a reduction of weight due to moisture desorption as the sample comes up to a temperature of about 500° C. in pure N₂. Then, CO₂ is introduced into the gas stream at approximately 30 minutes by switching to a gas with composition of ˜14% CO₂ with the balance N₂. After a few minutes of exposure to this CO₂-containing gas, the gas stream is switched back to pure N₂ and some surface desorption of the CO₂ is observed. This introduction of CO₂-containing gas followed by a period of exposure to pure N₂ is repeated for about 2 hours. At the end of this test period, the total irreversibly absorbed CO₂ is about 0.1% of the sample weight, whereas during the test an additional reversibly absorbed CO₂ (seen during each cycle) was an additional approximately 0.1% of the sample weight. FIG. 1 shows the slow kinetics of as-received olivine for mineral carbonation.

Among the disclosed sample preparation conditions, it may be preferred to use samples prepared according to the method disclosed for sample G since those samples are expected to have preferred performance from the relatively higher surface area observed. A general observation regarding this preferred preparation method is that the milling process is conducted with a silicate:oxide ratio that contains more silicate than oxide, such as a preferred ratio of about 3:1, though a ratio from between about 1:1 about 20:1 may be acceptable. Another observation is that the preferred wet milling process is conducted with a solids:liquid ratio of between about 1:1 and about 1:2, though a ratio between about 1:0.5 and about 1:3 may be acceptable, wherein the general goal is to minimize liquid usage. One possible liquid is water, but other more volatile water-soluble solvents may be used to minimize the drying energy required. Another observation is that the wet milling process is preferably conducted at slightly elevated temperatures; such as about 60° C., though a temperature between ˜35° C. and ˜85° C. may be acceptable, a temperature between ˜50° C. and ˜70° C. may be more preferred. Room temperature milling may be adequate when other parameters are selected appropriately. Another observation is that ˜7 hours of milling was generally sufficient for the creation of surface area, extending the time to ˜24 hours did not appear to provide significant benefit; it is possible that process optimization could reduce the milling time further, perhaps to as little as ˜4 hours. Another observation is that the preferred wet milling process is conducted to generate a mineral carbonation precursor material with surface area of about 15 m²/g or greater; it should be understood that a higher surface area is generally better for mineral carbonation conversion rate.

FIG. 2 shows the mineral carbonation response of a material prepared according to the disclosed process. The sample material used in FIG. 2 was prepared according to the parameters of sample G as listed in Table 1, this material has a surface area of 25.8 m²/g. The test involved an initial drying/heating time under pure N₂ that was followed by cyclical introduction of CO₂ (˜14% CO₂ gas with the balance N₂) for a few minutes that was alternated with exposure to pure N₂ for a few minutes; which is similar to the test that was performed on the olivine sample reported in FIG. 1. The first approximately 35 minutes of the test shows a reduction of weight as adsorbed moisture was driven off. The plateau of the trace indicates that the sample absorbed ˜11% of its weight in CO₂. Furthermore, under cyclical introduction of CO₂, there was no observable desorption of CO₂ as was observed during the test that is shown in FIG. 1. It is notable that most of the CO₂ uptake was accomplished in the first few minutes after its introduction.

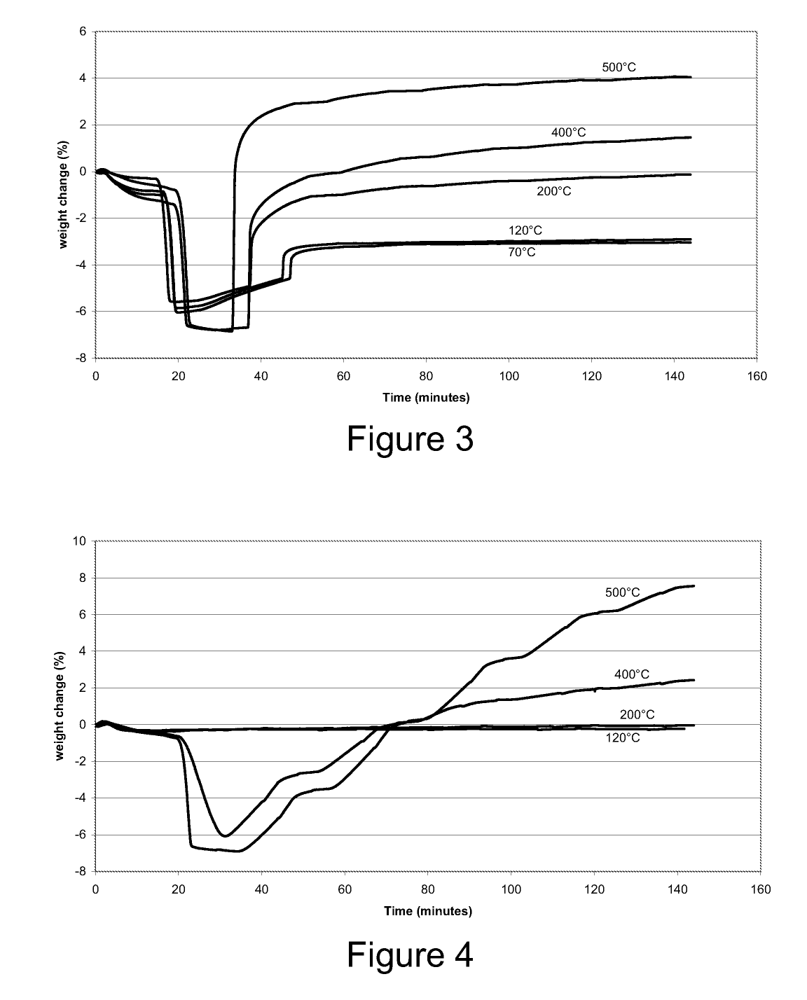

FIG. 3 shows absorption traces for a sample of mineral carbonation precursor material prepared according to the preferred method disclosed for sample G. These CO₂ absorption traces are plotted for various temperatures. The test involved an initial drying/heating time under pure N₂ (persisting for between ˜35 minutes and ˜50 minutes for the various samples) that was followed by carbonation. These samples were subjected to the same cyclical introduction of CO₂ (˜14% CO₂ gas with the balance N₂) for a few minutes that was followed by exposure to pure N₂ for a few minutes. Similar to FIG. 2, there was no observable desorption of the CO₂ during the time the samples were exposed to pure N₂. The storage capacity of this mineral carbonation precursor material improved from ˜3% at temperatures below about 300° C. to ˜11% mineral carbonation conversion at about 500° C.

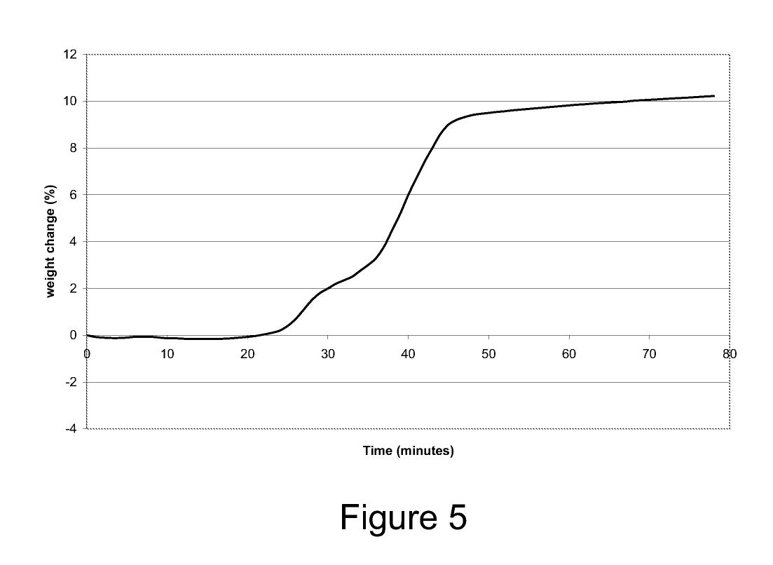

FIG. 4 shows absorption traces for SO₂ at various temperatures. These experiments were conducted on samples prepared according to the process disclosed for sample G in Table 1. The test involved an initial drying time under pure N₂ followed by cyclical introduction of about 3000 ppm SO₂ in N₂ that was alternated with periods of exposure to pure N₂. Tests were conducted at various temperatures to determine the mineral conversion rate under different conditions. As can be seen in the chart, the absorption of SO₂ is still increasing at the end of this test period and attained ˜14.5% weight change at the end of the test period. No desorption of SO₂ was observed under periods of pure N₂ exposure.

FIG. 5 shows an absorption trace for mineral carbonation precursor material prepared according to this disclosure in simulated flue gas with a composition of 10% CO₂, 500 ppm CO, 3000 ppm SO₂ 5% O₂, balance N₂. This test was conducted at 500° C. and shows a ˜10% weight change. The reaction product showed evidence of both magnesium sulfate and calcium carbonate.

The mineral carbonation precursor materials that were tested as a part of the experiments disclosed in FIGS. 1-5 were produced from a slurry that was then subjected to an evaporation process before being evaluated for mineral carbonation conversion rate testing. An alternative means of utilizing the mineral carbonation precursor would be the use of it directly from a slurry. It is possible that the use of said slurry would be advantageous from a product delivery perspective. For example, desulfurization in existing flue gas cleaning processes is often conducted by atomizing a slurry or solution that contains the active sulfur-capturing material in the exhaust gas stream. Equipment used previously for desulphurization may be effective in CO₂ capture as well as SO₂ capture.

Although not wishing to be bound by theory, some elemental analysis of the mineral carbonation precursor materials as prepared by the methods disclosed show that beyond simply mixing the silicate and the oxide, ionic exchange may also occur. For example, when Mg₂SiO₄ is wet milled in the presence of CaO the calcium may exchange with some of the magnesium in the silicate to produce a MgₓCa₍₂₋ₓ₎SiO₄. This synthetic mineral precursor may have carbonation performance greater than either the starting magnesium silicate or calcium silicate (Ca₂SiO₄). The CaO source may include industrial waste products such as cement kiln dust (CKD), blast furnace slag, and fly ash.

### INDUSTRIAL APPLICABILITY

Mineral carbonation is applicable to stationary exhaust producers; this is envisioned to be most applicable to the flue gases of power plants (including coal burning facilities, gas turbines, stationary internal combustion engine generator sets), and stationary motors for other needs (e.g. engines that may be used for pumping and industrial processes). It is possibly advantageous to locate power generation facilities near the mining location for the desired silicate that would be used for the mineral carbonation precursor material.

What is claimed is:

1. A method for producing a mineral carbonation precursor material comprising:
combining an alkaline earth metal silicate and an alkaline earth metal oxide in a slurry,
wet-milling said slurry for more than about 4 hours with grinding media, said slurry containing more alkaline earth metal silicate than alkaline earth metal oxide.

2. A method according to claim 1 wherein:
the wet-milling includes a solids:liquid ratio of between about 1:0.1 and about 1:3.

3. A method according to claim 2 wherein:
the wet-milling conducted at a temperature between about 35° C. and about 85° C.

4. A method according to claim 3 wherein:
the wet-milling includes a silicate:oxide ratio of between about 1:1 and about 20:1.

5. A method according to claim 1 wherein:
the wet-milling conducted under conditions sufficient to generate a mineral carbonation precursor material with surface area greater than about 15 m²/g.

6. A method according to claim 1 wherein:
the wet-milling said includes a solids:liquid ratio of between about 1:1 and about 1:2.

7. A method according to claim 6 wherein:
the wet-milling is conducted at a temperature of between about 50° C. and about 70° C.

8. A method according to claim 7 wherein:
the wet-milling includes a silicate:oxide ratio of between about 2:1 and about 4:1.

9. A method for producing a mineral carbonation precursor material comprising:
combining a magnesium-containing silicate and calcium oxide in a slurry, wet-milling said slurry for more than 4 hours with grinding media, said slurry containing more magnesium silicate than calcium oxide.

10. The method of claim 9 wherein said magnesium-containing silicate is selected from the group of naturally occurring mineral classes consisting of olivine, serpentine, peridotite, pyroxene, monticellite, tremolite, diopside, and combinations thereof.

11. A method according to claim 9 wherein:
the wet-milling includes a solids:liquid ratio of between about 1:0.1 and about 1:3.

12. A method according to claim 11 wherein:
the wet-milling conducted at a temperature between about 35° C. and about 85° C.

13. A method according to claim 12 wherein:
the wet-milling includes a silicate:oxide ratio of between about 1:1 and about 20:1.

14. A method according to claim 9 wherein:
the wet-milling conducted under conditions sufficient to generate a mineral carbonation precursor material with surface area greater than about 15 m²/g.

15. A method according to claim 9 wherein:
the wet-milling said includes a solids:liquid ratio of between about 1:1 and about 1:2.

16. A method according to claim 15 wherein:
the wet-milling is conducted at a temperature of between about 50° C. and about 70° C.

17. A method according to claim 16 wherein:
the wet-milling includes a silicate:oxide ratio of between about 2:1 and about 4:1.

18. A mineral carbonation precursor material produced by combining a magnesium-containing silicate and calcium oxide in a slurry, wet-milling said slurry for more than 4 hours with grinding media, wherein said slurry contains more magnesium-containing silicate than calcium oxide.

19. The mineral carbonation precursor material of claim 18 wherein:
the magnesium-containing silicate is selected from the group of naturally occurring mineral classes consisting of olivine, serpentine, forsterite, peridotite, pyroxene, monticellite, tremolite, diopside, and combinations thereof.

20. The mineral carbonation precursor material of claim 18 wherein:
the calcium oxide content is provided by cement kiln dust, blast furnace slag, fly ash, other calcium oxide containing industrial waste product, or combinations thereof.
